(19) United States
(12) Patent Application Publication
(10) Pub. No.: US 2010/0155177 A1
(43) Pub. Date: Jun. 24, 2010

(54) Portable workstation for a ladder

(76) Inventor: William F. Tydings, III, Edgewater, MD (US)

Correspondence Address: William F. Tydings, III, 3874 Holly Drive, Edgewater, MD, 21037, US

(21) Appl. No.: 12/545,766

(22) Filed: Aug. 21, 2009

Related U.S. Application Data
(60) Provisional application No. 61/140,755, filed on Dec. 24, 2008.

(51) Int. Cl. E06C 7/14; E06C 7/00; B65D 25/00

(52) U.S. Cl. 182/129; 220/475

(57) ABSTRACT

A portable workstation for a ladder includes: a base section having a work area; a supporting surface adapted to rest upon an outer surface of the legs; a retaining section adapted to extend between and past the legs; a lateral cavity in a lower surface of the retaining section, adapted to engage with the rung; and a lateral aperture in the retaining section, adapted to receive a rod underneath the legs of the ladder that extends beyond the legs of the ladder so as to press up against an inner surface of the legs. When the rod is inserted into the aperture, the workstation rests upon the legs and rung, and the rod presses up against the legs to retain the workstation.

### RELATED APPLICATIONS

The present application claims benefit of priority from U.S. Provisional Application No. 61/140,755, filed Dec. 24, 2008, which is incorporated herein by reference in its entirety.

### BACKGROUND OF THE INVENTION

The present invention generally relates to attachments for ladders, and more specifically, to a portable workstation for a ladder.

Existing workstations are either permanently attached to the ladder, or do not provide a horizontal work place on the back of the ladder.

As can be seen, there is a need for a more efficient and effective portable ladder workstation.

### SUMMARY OF THE INVENTION

In one aspect of the present invention, a workstation utilizing a ladder having legs and a rung between the legs includes: a base section having a work area; a supporting surface adapted to rest upon an outer surface of the legs; a retaining section adapted to extend between and past the legs; a lateral cavity in a lower surface of the retaining section, adapted to engage with the rung; and a lateral aperture in the retaining section, adapted to receive a rod underneath the legs of the ladder that extends beyond the legs of the ladder so as to press up against an inner surface of the legs; wherein, when the rod is inserted into the aperture, the workstation rests upon the legs and rung, and the rod presses up against the legs to retain the workstation.

In another aspect of the present invention, a method of utilizing a workstation and a ladder includes: resting a supporting surface of the workstation on an outer surface of a leg of the ladder; extending a retaining section of the workstation past the leg of the ladder; engaging a lateral cavity in a lower surface of the retaining section with a rung of the ladder; and inserting a rod in a lateral aperture of the retaining section underneath the legs of the ladder so that the rod extends beyond the legs of the ladder and presses up against an inner surface of the legs of the ladder; wherein, when the rod is inserted into the aperture, the workstation rests upon the legs and rung, and the rod presses up against the legs to retain the workstation.

These and other features, aspects and advantages of the present invention will become better understood with reference to the following drawings, description and claims.

### BRIEF DESCRIPTION OF THE DRAWINGS

FIG. 1 depicts a side view of an embodiment of the present invention in use on a ladder;

FIG. 2 depicts a side view of an embodiment of the present invention in use on a ladder;

FIG. 3 depicts a back view of an embodiment of the present invention in use on a ladder;

FIG. 4 depicts a top view of an embodiment of the present invention;

FIG. 5 depicts a side view of an embodiment of the present invention;

FIG. 6 depicts a side view of an embodiment of a moveable center support section according to the present invention;

FIG. 7 depicts a side view of an embodiment of a die and cap according to the present invention; and

FIG. 8 depicts a top view of an embodiment of a die attached to a wall according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally relates to a portable workstation for a ladder.

An embodiment of the present invention includes a rectangular tray device that will hold in place copper pipe, electrical conduit, ½″, ¾″ and 1″ sizes, all thread rods ¼″, ⅜″ and ½″ sizes, also ¾″ and 1.5″ support channel. As an example material, the tray can be made from, plastic, metal, or wood, etc. The tray depth allows storage space for tools and hardware, or the like.

An embodiment of the present invention attaches to a ladder without drilling or any modifications to the ladder. Embodiments may be attached to a 6 foot or 8 foot ladder that allows materials to be cut or assembled safely and efficiently without leaving the work area.

An embodiment may be called “the Ladder Work Station,” which is mounted on the back side of the ladder. This provides a safe and stable work area, and reduces the hazard of tools or materials falling from the top of a ladder. An embodiment holds materials firmly in place while work is performed. Embodiments can hold materials up to 10 feet in length. Embodiments have a portable design so the work station can be removed while relocating the ladder.

Other embodiments can be mounted to a work bench, work cart, or gang box.

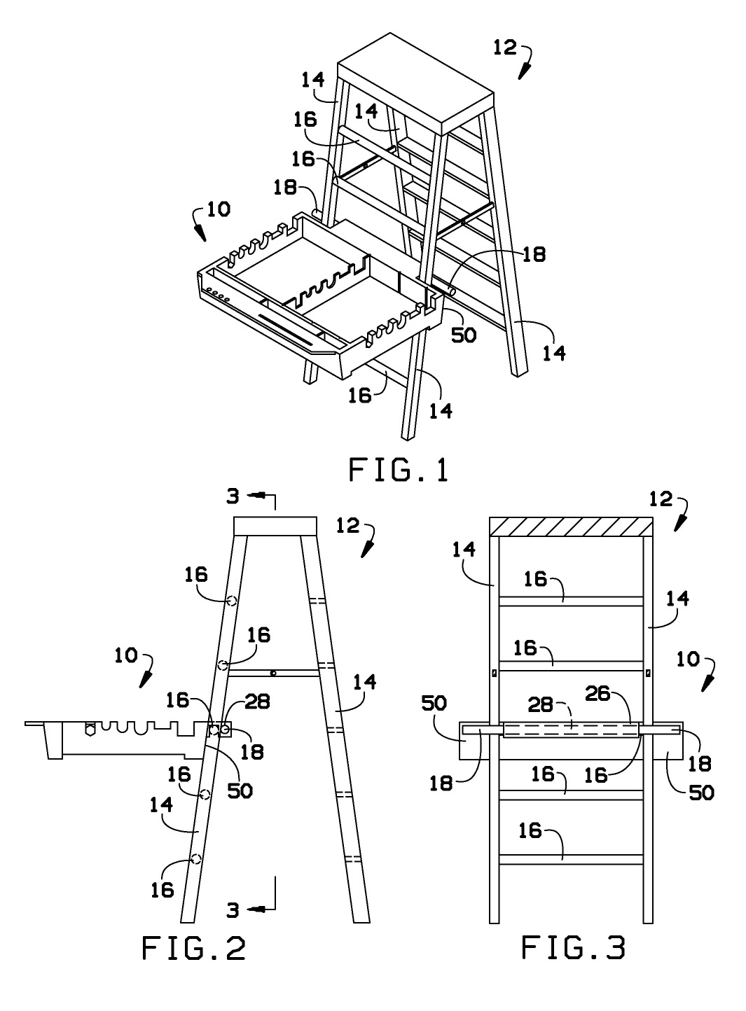

As depicted in the embodiments of FIGS. 1, 2 and 3, a ladder workstation 10 attaches to a ladder 12 having legs 14 and rungs 16 between the legs 14. The ladder 12 has a front side with flat steps for the user to climb up and down, and a backside with round rungs 16 where the workstation 10 will attach. A removable rod 18 holds is inserted into an aperture 20 behind the legs 14 to help hold the workstation 10 in place. The workstation 10 has angled surfaces 50, relative to vertical, on the left and right sides that rest upon the outer surface of the legs 14 to help hold the workstation in a horizontal position that extends out from the back of the ladder. Exemplary ranges of this angle are those of typical ladder angles, such as approximately 15 degrees. The user can work on a work piece using the workstation without leaving the area of the ladder.

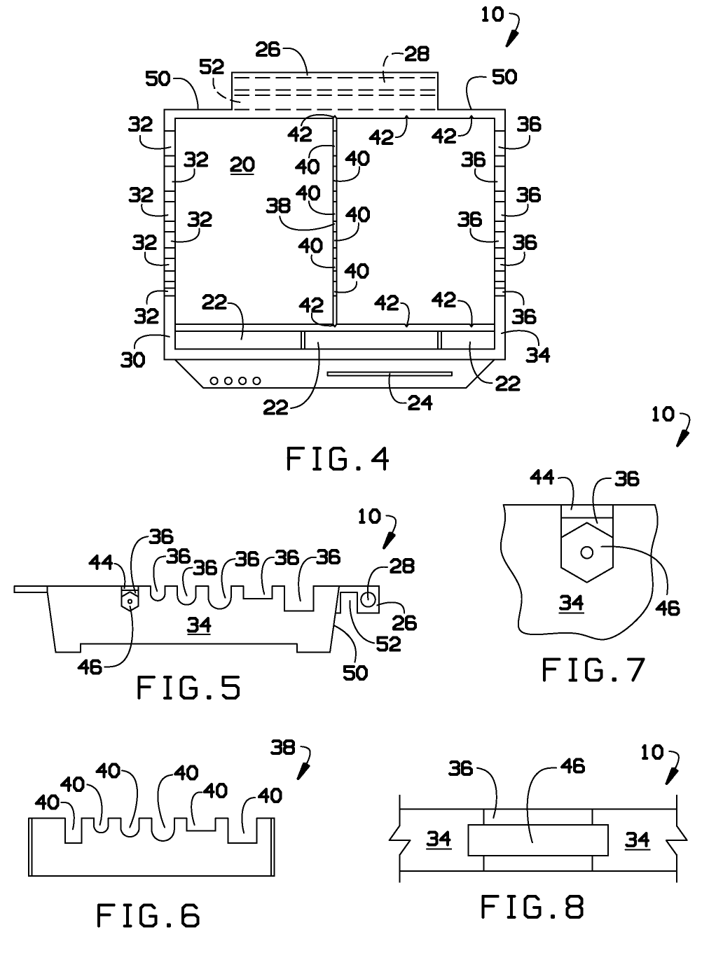

As depicted in the embodiment of FIG. 4, the workstation 10 includes a base section 20 that is a tray to act as the work area for the ladder user. The base section 20 has storage bins 22, a pencil holder 24, and a container area for the user to work in. The workstation has a retaining section 26 that is narrower than the space between the legs of the ladder. The retaining section 26 extends between and past the legs, so that it can rest on the rung of the ladder. The retaining section 26 also has a lateral aperture 28 running the width of the retaining section, and the user inserts a rod in this aperture. The rod could be a piece of PVC tubing, and the aperture 28 could be circular, about ⅞ inches in diameter. When the rod is inserted, the rod is underneath the legs of the ladder. The rod extends beyond the legs of the ladder and presses against the inner surface of the legs. The workstation rests upon the legs and rung, and the rod presses up against the legs to retain the workstation in a horizontal position so that the user can work on a work piece.

Embodiments of the workstation include a left wall 30 and a right wall 34 attached to the base section 20, and the walls 30, 34 have depressions 32, 36 in which a work piece such as a section of pipe or conduit is rested. The depressions 32 in the left wall 30 are opposite from and similarly shaped to the depressions 36 in the right wall 34. The depressions 32, 36 retain the work piece above the base section 20 so that a user of the ladder can work upon the work piece.

Embodiments include a central support section 38 that is releasably attached to the base section 20 having depressions 40 that match the depressions 32, 36 in the walls 30, 34 to further help support the work piece. An embodiment includes a base section 20 having top and bottom sides with notches 42 to attach the central support section 38 in different positions and then release it from the base section 20.

FIG. 5 depicts a side view of an embodiment of the workstation 10. The retaining section 26 has a lateral cavity 52 running side-to-side in its lower surface that slips over and engages with the ladder rung. This cavity 52 may be about 1 inch in width, or just wide enough to slip over a rung on the back side of a ladder. The retaining section 26 also has a lateral aperture 28 running the width of the retaining section, into which the user inserts a rod. An embodiment includes depressions 36 with round lower surfaces, to hold round items like pipe, depressions 36 with flat lower surfaces, to hold square rods, and a depression 36 with a triangular lower surface, to hold hexagonal work pieces. An embodiment includes a depression in one of the walls adapted to retain a die 46, such as for threading support rod, and a cap 44 to hold the die 46 in place.

In one example, the depressions 36 may be of the following dimensions: a triangular depression, 1″ in width, in which a hexagonal rod or die could rest; three depressions with bottoms in the shape of circular arcs which are 0.875″, 1.125″, and 1.375″ in width, respectively, in which round rods or conduit having matching diameters could rest; and two depressions with flat bottoms which are both 1.75″ in width, but which have depths of 0.75″ and 1.5″ respectively, in which flat or other-shaped miscellaneous work pieces could rest.

FIG. 6 depicts a side view of an embodiment of the moveable central support section 38. The central support section 38 moves by sliding it into or out pairs of notches in the base section. The depressions 40 line up with the depressions in the left and right walls.

FIG. 7 depicts a side view of a die 46 held in a triangular depression 36 in one of the walls 34. A removable cap 44 holds the die 46 in place. The cap 44 might either slide into place or snap into a retainer above the die 46.

FIG. 8 depicts a top view of a die 46 held in the depression 36 of right wall 34. The die 46 could be held in either wall, or in the center support section.

It should be understood, of course, that the foregoing relates to exemplary embodiments of the invention and that modifications may be made without departing from the spirit and scope of the invention as set forth in the following claims.

We claim:

1. A workstation utilizing a ladder having legs and a rung between the legs, the workstation comprising:
a base section having a work area;
a supporting surface adapted to rest upon an outer surface of the legs;
a retaining section adapted to extend between and past the legs;
a lateral cavity in a lower surface of the retaining section, adapted to engage with the rung; and
a lateral aperture in the retaining section, adapted to receive a rod underneath the legs of the ladder that extends beyond the legs of the ladder so as to press up against an inner surface of the legs;
wherein, when the rod is inserted into the aperture, the workstation rests upon the legs and rung, and the rod presses up against the legs to retain the workstation.

2. The workstation of claim 1 further comprising:
a left wall attached to the base section, having a first depression adapted to support a first portion of a work piece; and
a right wall attached to the base section, having a second depression adapted to support a second portion of the work piece;
wherein the first and second depressions cooperate to retain the work piece above the base section so that the work piece can be accessed by a user of the ladder.

3. The workstation of claim 1 further comprising:
a left wall attached to the base section, having a plurality of first depressions adapted to support work pieces; and
a right wall attached to the base section, having a plurality of second depressions adapted to support the work pieces, each of the second depressions corresponding to a first depression, each second depression being generally opposite from its corresponding first depression;
wherein the corresponding depressions cooperate to retain the work pieces above the base section so that the work pieces can be accessed by a user of the ladder.

4. The workstation of claim 3, wherein the depressions include a depression with a round lower surface, a depression with flat lower surface, and a depression with a pointed lower surface.

5. The workstation of claim 1, further comprising:
a wall having a depression adapted to retain a die; and
a removable cap to hold the die in place;
wherein the die is retained over the base section so that a user of the workstation can utilize the die.

6. The workstation of claim 1 further comprising:
a left wall attached to the base section, having a first depression adapted to support a first portion of a work piece;
a right wall attached to the base section, having a second depression adapted to support a second portion of the work piece; and
a support section releasably attached to the base section between the left wall and the right wall, having a third depression adapted to support a third section of the work piece;
wherein the first, second, and third depressions cooperate to retain the work piece above the base section so that the work piece can be accessed by a user of the ladder.

7. The workstation of claim 6 further comprising:
a plurality of attachment mechanisms in the base section to retain the support section in different positions.

8. The workstation of claim 1, wherein the supporting surface is angled so that, when it rests upon the legs, the base section is held in a generally horizontal position.

9. A method of utilizing a workstation and a ladder, the method comprising:
resting a supporting surface of the workstation on an outer surface of legs of the ladder;
extending a retaining section of the workstation between and past the legs of the ladder;
engaging a lateral cavity in a lower surface of the retaining section with a rung of the ladder; and
inserting a rod in a lateral aperture of the retaining section underneath the legs of the ladder so that the rod extends beyond the legs of the ladder and presses up against an inner surface of the legs of the ladder;
wherein, when the rod is inserted into the aperture, the workstation rests upon the legs and rung, and the rod presses up against the legs to retain the workstation.

10. The method of claim 9 further comprising:
providing a left wall having a plurality of first depressions;
providing a right having a plurality of second depressions, each of the second depressions corresponding to a first depression, each second depression being generally opposite from its corresponding first depression; and
supporting a work piece with one of the first depressions and the corresponding second depression;
wherein the corresponding depressions cooperate to retain the work piece above the base section so that the work piece can be accessed by a user of the ladder.
